(19) United States
(12) Patent Application Publication
(10) Pub. No.: US 2003/0152411 A1
(43) Pub. Date: Aug. 14, 2003

(54) Nail care accessory

(76) Inventor: Nicci Prokopos, Sunnyside (ZA)

Correspondence Address: SHERIDAN ROSS PC, 1560 BROADWAY, SUITE 1200, DENVER, CO, 80202

(21) Appl. No.: 10/311,480

(22) PCT Filed: Jun. 12, 2001
(86) PCT No.: PCT/ZA01/00078

(30) Foreign Application Priority Data
Jun. 16, 2000 (ZA) 2000/2395

(51) Int. Cl. A47L 13/22; B43K 7/12

(52) U.S. Cl. 401/117; 401/183; 401/270

(57) ABSTRACT

A nail care accessory which is in a form of a housing with a tight fitting lid which can be pulled off to reveal an applicator to which a nail varnish, nail varnish remover or other substance for treatment of the nails, is conveyed by internal channels from a reservoir inside the housing. The applicator is protruded and retracted by applying pressure to elastic parts of the housing. The reservoir may be replaceable or refillable or the reservoir and applicator as a unit may be exchanged to allow use of different colours. A nail varnish applicator and a nail varnish remover can be incorporated in a single accessory, located end to end so that one is at one end and the other at the other end, of the accessory. A flow control valve may be provided, actuated by pressure on the applicator when substance is being applied to a nail. The walls of eth reservoir can be made compressible to allow pressure to be applied, to place the substance under pressure, to assist in it coming out of the accessory at the applicator.

### FIELD OF THE INVENTION

This invention lies in the field of manicure and pedicure, especially the application of nail varnish and other cosmetic and medicinal substances for the care of finger nails and toe nails.

### BACKGROUND

The application of substances used in the care of nails is presently tedious and inconvenient, the majority of people do not use the services of a manicurist but do it themselves. These adverse aspects are experienced both in the application of nail varnish and other nail treatments and the removal of thereof.

The means of applying substance to the nails, which is widely in use at present for nail varnishes, comprises a bottle with a brush, usually fitted in the lid of the bottle. The varnish is applied by unscrewing the bottle cap, withdrawing the brush attached to the cap and brushing the varnish onto the nails. If the bottle falls over, the varnish, due to its properties, damages table tops, surfaces of vehicle finishes, carpets or floors etc. onto which it may fall. The varnish dries quite rapidly, to attain the advantage of drying rapidly on the nails, but this must be countered by dipping the brush frequently into the bottle, until the application to the nails of both hands, and/or feet, is complete. The contents of the bottle tend to dry prematurely, wasting much of the varnish.

Removal of nail varnish is at present widely done using a bottle of varnish remover and cotton swabs. The remover is usually acetone based and hence is a volatile and aggressive liquid. The liquid causes a penetrating smell, evaporates quickly and quickly causes damage to surfaces onto which it may fall. The swabs must be doused with acetone, used to wipe the nails and carrying the residual acetone and also the removed varnish, be safely disposed. Handling the swab results in the acetone removing natural oils from the skin, where the swab is grasped.

These disadvantages are unpleasant and potentially harmful and a problem in the use of substances for nail care.

### THE INVENTION

The solution of these problems in accordance with the invention, is to provide an accessory for a nail care substance which has a reservoir for the substance, an applicator for the substance and is characterised by channels for conveying the substance from the reservoir to the applicator and by a means of enclosing the applicator within a housing of the accessory.

Preferably the applicator is retractable into a housing of the accessory, when not in use, extendable when in use, preferably by a simple pressure applied to the accessory.

Preferably this feature is enabled by means of an area or areas of the accessory housing being capable of being squeezed with a mechanism inside which, is activated when the accessory is squeezed, to move the applicator outside the housing. Preferably a second squeeze is effective to allow the applicator to return into the housing under spring action.

Preferably the accessory in addition to this feature has a cap, which can be placed over the end of the accessory where the applicator can be extended and withdrawn, to seal the ambient from the interior of the accessory.

It is found that the best form of applicator is a brush and in this case the channels from the reservoir lead to the side of the bristles near their base. Other applicators can be used, including a porous material such as a felt tip, foamed plastic, non-woven material, ball tip, etc. The applicator can be made replaceable, e.g. simply by pulling out against a click action or a firm fit and pushing in another one.

Preferably the accessory reservoir is disposable and replaceable with refill packs. Provision could be made alternatively for the reservoir to be refillable.

A flow control valve can be incorporated in the accessory and the reservoir can be made compressible, arranged so that squeezing the accessory housing squeezes the reservoir so placing its contents under pressure. This can assist delivery of the nail care substance. This can be helpful if the substance is fairly viscous or has become so as a result of drying over a long period. This could happen if, for example, the preferred cap is forgotten and not replaced after use to seal the accessory.

A convenient embodiment of the invention is to provide two applicators each with its own reservoir end-to-end, for example carrying different colours which can be applied at each end, or one carrying nail varnish which can be applied at one end and the other carrying nail varnish remover which can be applied at the other end, etc.

The accessory can be made entirely disposable, this can be done by making the reservoir a simple flexible bag or tank which can be squeezed to expel the substance from the reservoir to the applicator. The applicator can be enclosed by means of a cap, which can be closed onto the reservoir with a sealing fit, e.g. pushed onto on tapered surfaces.

### THE DRAWINGS

The invention will be more fully described by way of non-limiting examples, with reference to the drawings.

In the drawings:

FIG. 1 shows a preferred embodiment of the invention, with a cap removed for nail varnish application,

FIG. 2 shows a preferred embodiment of the invention, with a cap removed for nail varnish remover application,

FIG. 3 shows a refill capsule for the accessory,

FIG. 4 shows a nail varnish part which can be substituted, with a different colour,

FIG. 5 shows in schematic front cross sectional view, another embodiment of the invention,

FIG. 6 shows a side view of the embodiment shown in FIG. 5,

FIGS. 7, 8 and 9 show “exploded views of interior parts of the embodiment shown in FIGS. 5 and 6,

FIG. 10 shows in schematic cross sectional view, a further embodiment of the invention,

FIG. 11 shows in schematic cross sectional view, a still further embodiment of the invention,

FIG. 12 shows in schematic cross sectional view, a still further embodiment of the invention,

FIG. 13 shows “an exploded view of interior parts of the embodiment shown in FIG. 12,

FIG. 14 shows alternative tips for the embodiment shown in FIGS. 12 and 13, and

FIG. 15 shows in schematic cross sectional view, a still further embodiment of the invention.

### THE PREFERRED EMBODIMENTS

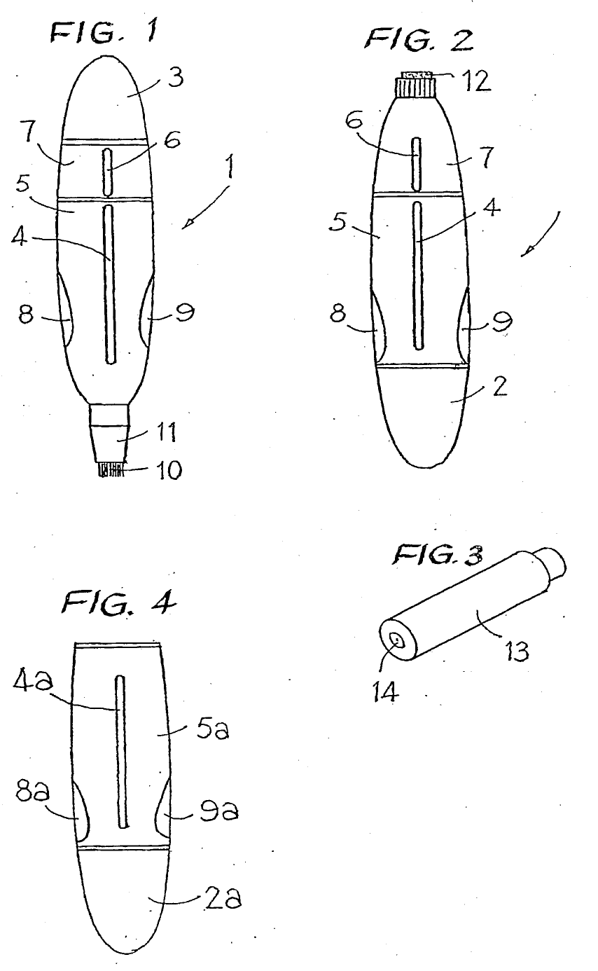

FIGS. 1 and 2 show an accessory 1 which has a cap 2 for a nail varnish applicator and a cap 3 for a nail varnish remover applicator. A window 4 in housing 5 allows the colour and quantity of nail varnish to be seen and window 6 in housing 7 shows the quantity of nail varnish remover. The housings 5 and 7 are screwed together and can be unscrewed. The caps are push fits onto the housings. Two elastic parts 8 and 9 of the body of the accessory can be squeezed, to make the nail varnish applicator 10 move out of the accessory, for use. Upon releasing these parts the applicator returns automatically into the body. The cap 2 completes the enclosing of the applicator so that it does not dry out. The nail varnish applicator is brush bristles in a collar 11. The nail varnish remover applicator 12 is a sponge or felt tip type of applicator, which is fixed in position, but enclosed as well, when the cap 3 is replaced.

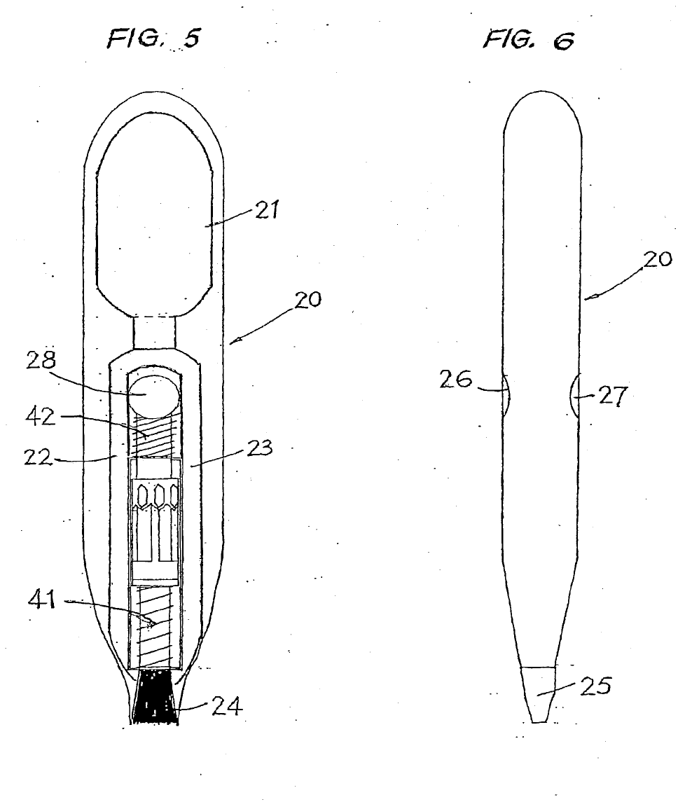

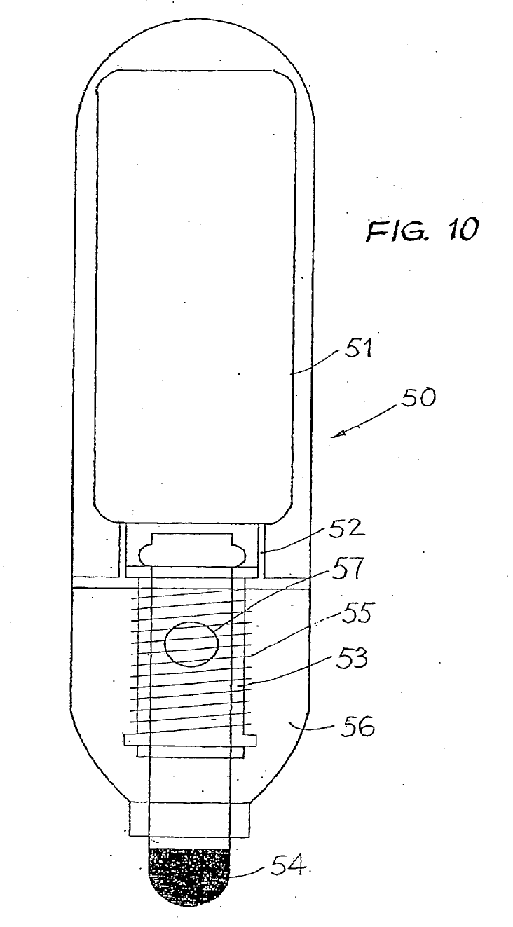

The internal parts are similar to those of the embodiments described with reference to FIGS. 5 and 10 and these descriptions are referred to.

FIG. 3 shows a refill capsule 13 for the nail varnish, which can be inserted after removal of an old one, which is exhausted. The hole 14 is sealed by a thin membrane until use, when it is perforated when the housing is connected to the accessory.

FIG. 4 shows a substitute housing 5a which can be screwed onto the housing 7, to change the colour of the varnish. The housing has the analogous parts 8a, 9a and 2a.

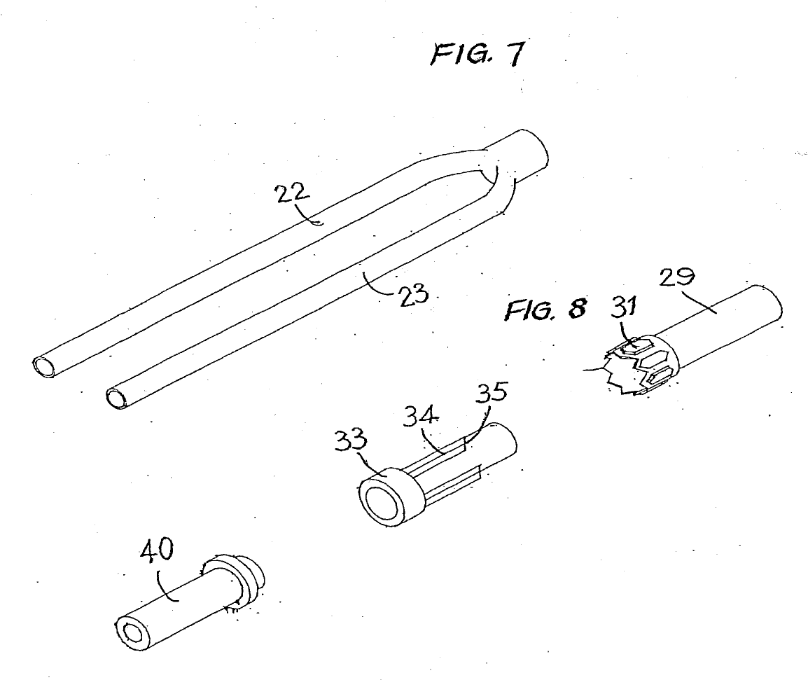

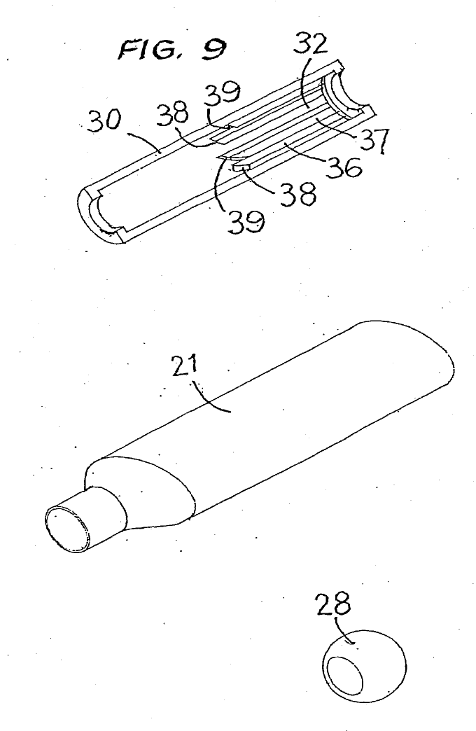

FIGS. 5 and 6 show an accessory, with FIG. 5 showing internal parts and FIGS. 7 to 9 these parts in “exploded” view.

This is an accessory for application of nail varnish only. The design of its internal parts can, however, also be applied to the nail varnish applicator part of the embodiment shown in FIGS. 1 and 2.

The accessory comprises a housing 20, which contains a reservoir 21 with channels 22 and 23 which lead to the base area of a brush applicator 24. A cap 25 (not shown in FIG. 5) encloses the brush, when not in use, being removed for use. The housing has two elastic spots 26 and 27, which can be squeezed in order to cause the brush applicator to protrude from the housing, for application of nail varnish. The mechanism causes the brush to protrude upon first squeezing and to return under spring action into the housing upon second squeezing, and so on. Each alternate squeezing either protrudes the brush, or allows it to retract.

The mechanism, which allows this, is shown in FIGS. 5 and 7 to 9. It may be mentioned here that the reservoir 21 is either permanently fixed, or it may be replaceable, as mentioned with reference to FIG. 3. The mechanism comprises a ball 28, which is actuated by the elastic spots to move downwards, towards the end of the housing, which has the brush. The ball moves a piston 29 which can slide down and up without rotation inside a sleeve 30 (which is shown sectioned in half to aid illustration), the diamond shaped protrusions 31 on the piston sliding in the grooves 32 of the sleeve 30. The reciprocating of the piston down and up moves a follower 33 down and up, but the diamond formations 31 on the piston act onto ridges 34 of the follower, which ridges have oblique chamfered ends 35. The sleeve 30 has alternating ridges 36 and 37 between the grooves 32, which ridges have oblique chamfered ends 38 and 39 respectively and are of different length. The effect of this structure is that each time the piston reciprocates, the follower rotates and returns to rest on either the ridges 38 or the ridges 39. The follower acts on a bush 40, which holds the applicator brush (not shown in FIG. 8). A spring 41 (FIG. 5) returns the follower after being pushed down and a spring 42 returns the ball. The ridges 38 are longer than the ridges 39, when on the ridges 38 the brush is protruded and when on the ridges 39 the brush is retracted. When the brush is retracted, it can be enclosed by the cap, so as not to dry out and the nail varnish is fed via the channels 22 and 23.

FIG. 10 shows an accessory 50 suitable for nail varnish remover. It has a reservoir 51, which is connected to a channel formed by a collar 52 which leads to a cylinder 53. An applicator 54 is like a piston inside the cylinder 53. A spring 55 urges the cylinder and piston, which is held by a collar 56 around it in position in the cylinder. Upon pressure exerted on the applicator, it is depressed and a seal formed between the collar and the space 56 is opened allowing a feed of nail varnish remover liquid to move into the space 56. The liquid can pass via a hole 57 into the applicator and so feed it with the liquid. The outer end of the applicator is a permeable material, which allows the user to wipe liquid over the surface of a nail, to remove varnish. A cap (not shown) can be placed over the end bush 58 in a sealing fit, to enclose the applicator when not in use.

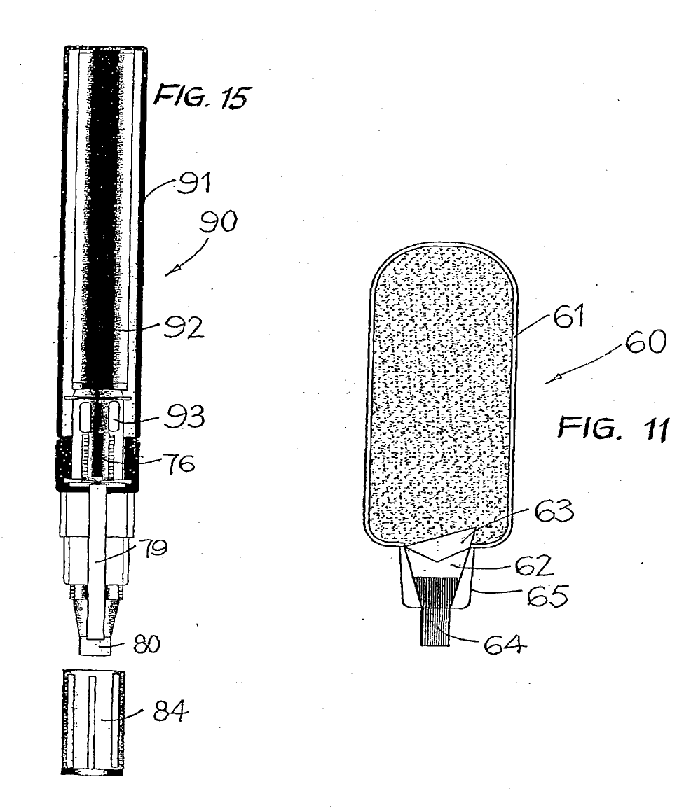

FIG. 11 shows an accessory 60, which works by squeezing the reservoir 61 of the accessory. A channel 62 for the nail varnish or nail varnish remover contained in the reservoir is normally close doff from the reservoir by a valve element 63 which is hinged by means of a thin plastic hinge. The channel leads to an applicator 64, which is shown as brush bristles. Upon squeezing the reservoir, the liquid in the reservoir is pressurised and opens the valve element, to pass into the channel and thence to the applicator. A cap (not shown) can be fitted over the end 65 of the accessory with a tight fit, to enclose the applicator and prevent drying out.

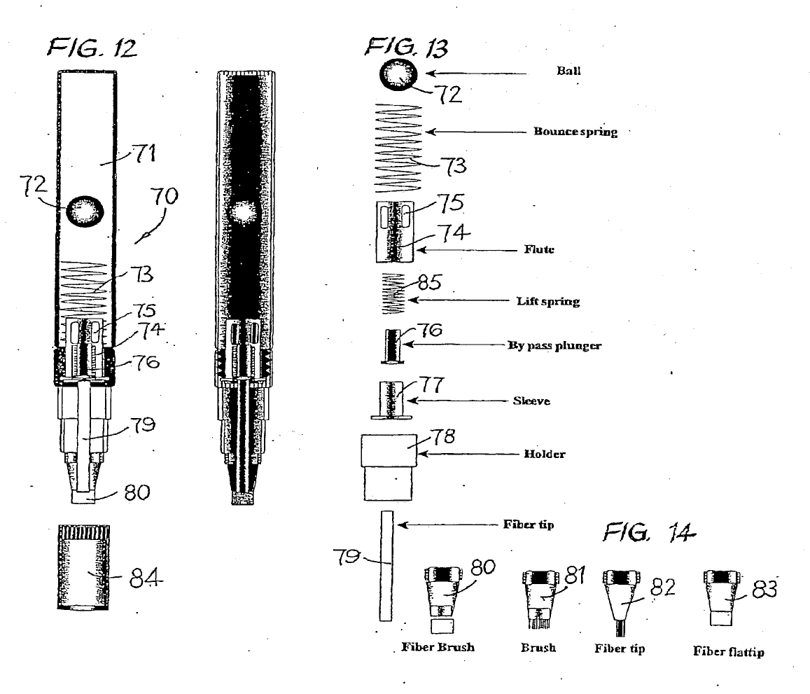

FIGS. 12 to 14 and 15 show accessories that have general similarities, but the former is disposable once the liquid (be it nail varnish or nail varnish remover) is finished while the latter has a refill cassette.

The accessory 70 is shown in FIG. 12 with interior parts shown in FIG. 13 to assist illustration. The accessory has a reservoir 71, which has a ball 72 in it to allow stirring the liquid by shaking the accessory, if this is necessary. A spring 73 allows a bounce action to the ball. A channel is formed by a flute 74 which has apertures 75 for liquid from the reservoir to enter the bore of the flute. A lift spring 85 acts on a by-pass plunger 76 which works in a sleeve 77. A holder 78 holds a fibre tip 79. When the accessory is used the plunger is lifted against action of the spring allowing liquid from the reservoir to pass to the fibre tip.

A choice of applicators is shown in FIG. 14, each can be screwed onto the end of the accessory and the liquid conveyed by the fibre tip passes to the applicator. The alternative applicators are a fibre brush 80, a bristle brush 81, a fibre tip 82 or a fibre flat tip 83. A cap 84 (FIG. 12) can be fitted tightly over the end of the accessory, to seal the applicator from the ambient.

The accessory 90 shown in FIG. 15 is similar in design to that shown in FIG. 12. It differs in that the accessory has a body 91 within which a reservoir 92 is contained, being a replaceable cassette or capsule. The flute 93 is modified to accept the cassette in a sealing manner yet allowing it to be removed and replaced. This is done, by making a firm fit between the two so that the cassette can be pressed onto the flute and pulled off when required, for the cassette to be changed Other parts are the same as the embodiment shown in FIGS. 12 to 14 and the description of them can be referred to.

1. An accessory for a nail care substance which has a reservoir for the substance, an applicator for the substance and is characterised by channels for conveying the substance from the reservoir to the applicator and by a means of enclosing the applicator within a housing of the accessory.

2. An accessory as claimed in claim 1, characterized in that the applicator is retractable into a housing of the accessory, when not in use, extendable when in use, by a pressure applied to the accessory, at an elastic area or areas of the accessory housing being capable of being squeezed, with a mechanism inside which is activated when the accessory is squeezed, to move the applicator outside the housing.

3. An accessory as claimed in claim 1, characterized in that the accessory has a mechanism by which a second squeeze is effective to allow the applicator to return into the housing under spring action, the mechanism comprising ball which moves a piston which can slide down and up without rotation inside a sleeve, diamond shaped protrusions being provided on the piston, sliding in grooves of the sleeve, and a follower having ridges which have oblique chamfered ends which are of different length.

4. An accessory as claimed in either one of claims 2 or 3, characterized in the accessory in addition having a cap which can be placed over the end of the accessory where the applicator can be extended and withdrawn, with a tight fit, to seal the ambient from the interior of the accessory.

5. An accessory as claimed in any one of claims 1 to 4, characterized in that the channels from the reservoir lead to the side of the applicator and the applicator is exchangeable, selected from a bristles brush, a felt tip, a foamed plastic, non-woven material, and a ball tip, the applicator being made replaceable simply by pulling out against a click action or a firm fit and pushing in another one.

6. An accessory as claimed in any one of claims 1 to 5, characterized in that the accessory reservoir is disposable and replaceable with refill packs, alternatively that the reservoir is refillable.

7. An accessory as claimed in any one of claims 1 to 6, characterized in that a flow control valve is incorporated in the accessory and the reservoir is made compressible, arranged so that squeezing the accessory housing squeezes the reservoir so placing its contents under pressure.

8. An accessory as claimed in any one of claims 1 to 7, characterized in that there is provided as a unitary product, two applicators each with its own reservoir located end-to-end, for carrying different colours which can be applied at each end, or one carrying nail varnish which can be applied at one end and the other carrying nail varnish remover which can be applied at the other end.

9. An accessory for care of nails as herein generally described.

10. An accessory for care of nails as herein specifically described with reference to any one of FIGS. 1 to 9, FIG. 10, FIG. 11 or FIGS. 12 to 15, of the drawings and as illustrated.
